(19) United States
(12) Patent Application Publication
(10) Pub. No.: US 2006/0016318 A1
(43) Pub. Date: Jan. 26, 2006

(54) Thunderline bolt on tremlo system

(76) Inventor: Stephen Edward Bayliss, Hereford (GB)

Correspondence Address: Mr. Stephen Edward Bayliss, Oakfeilds Kinnersley, Hereford, HR3 6PB, GB

(21) Appl. No.: 11/108,577

(22) Filed: Apr. 19, 2005

(30) Foreign Application Priority Data
Jul. 20, 2004 (GB) GB0416178.2

(51) Int. Cl. G10D 3/00

(52) U.S. Cl. 84/313

(57) ABSTRACT

A bolt on tremlo unit. The tremlo arm is depressed which rotates a shaft fitted within a frame. The rotating shaft pushes a con-rod against a tremlo tail stop. This forces it to tip thus lowering the pich of the strings When the tremlo arm is released, the expansion springs pull against a shaft spring connecting hinge and return the tremlo to its original position. When the tremlo arm is pulled across the frame causing the adjustable stop to clear the frame, the shaft is free to rotate in the oposite direction. This raises the pitch. When the adjustable stop is returned upon the stop block the guitar returns to standard pitch

### CROSS REFERENCE TO RELATED APPLICATIONS

A prior application has been made to the united kingdom of Great Britain patent office. Patent Application No. GBO416178.2

### STATMENT REGARDING FEDERALLY SPOSORED RESEARCH AND DEVELOPMENT

not applicable

### REFERENCE TO SEQUENCE LISTING A TABLE OR A COMPUTER PROGRAM UNDER COMPACT DISK APPENDIX

Not applicable

### BACKGROUND OF THE INVENTION

1. Feild of the Invention

The enclosed details of this invention refer to the feild of musical instruments, speciffically guitars/stringed instruments and their fitted tremlo devices

2. Description of Prior Art

Tremlos are often situated at the bridge end of the guitar/stringed instrument, thus a tremlo system is normally hand operated, slackening and tightening guitar strings above and below standard tuning pitch, which can also incorperated the guitar bridge into their design, or be separate unit which requires fitting with a certain amount of work.

A good tremlo will return to pitch after use which is usually the exact position it started from before use, yet Unfortunately there are very few low buget tremlos that will do this.

Tremlo devices are commomly found upon guitars with a 25½″ scale, because the string tension is much higher, thus the strings are able to balance against the pull of the strings, thus maintaining normal playing pitch and string tension with ease of operation above and below pitch, yet however when tremlos are fitted to guitars with a 24¾″ scale, the string tension is much less, thus when a tremlo is fitted the spring tension must be increased to compensate for the lower string tension.

However the result in operating action of the said tremlo is very hard and heavy which results in a tremlo that is difficult and requires alot of effort to use in practice, thus why tremlos are more common of 25½″ scale guitars and thus when tremlos upon shorter scale guitars have their springs slackened to affect an easier and more comfortable operating action, yet standard playing pitch, return to pitch and standard playing tension suffer, thus the result is a loss of clarity and inferiour sound of notes that would otherwise be acheived if the guitar was it's standard hard tail fixed bridge non-tremlo design, yet on a 25½″ scale guitar the string tension is the same for either tremlo/hard tail option, thus It is a common problem that has yet to be overcome.

Tremlos often require specalist routing out and cavities in order to be properly fitted, but tremlos can also be mounted directly on top of the guitar body, wherein this requires fitting which normally involves screwing pins directly into the guitar body, thus devaluing and damaging the guitar, to which as a result most short scale guitars tend to be of a hard tail fixed bridge non-tremlo design, thus also guitars with strings that pass directly through the body tend not any tremlo due to its difficulty to facilitate.

A large portion of hard tail bridges tend to be of the tune-o-matic design, thus comprising of a tail peice, of which the guitar strings slide through, to which the tail peice is the width of the base of the guitar kneck and is sespended away from the guitar body via two two threaded posts which are screwed into threaded inserts situated insided the guitar body, thus strings pass from the tail peice and over an adjustable bridge mounted in a similar configuration and size to the tail peice.

Friction also occurs in many tremlos where metal rubbs against metal, which thus prevents the tremlo from returning to its exact start position, promoting premature wear of parts to an unsatisfactory state, thus bearings have been known to be used to reduce friction, yet bearings are expensive and prone to collapse, thus jamming the tremlo and causing tuning problems.

To overcome these problems it would require a tremlo that can maintain standard hard tail tension with an easy operating action return to pitch after each operation, along with low friction falcrum points, thus maintaining tuning stability whilst also being cost efective to produce.

### STATEMET OF INVENTION

The presented invention is one that may be retrofitted onto any guitar of any designation, maintain good playing pitch, tuning stability and ease of operation without being expensive to produce.

### BREIF SUMMARY OF INVENTION

The present invention is a tremlo device which; can be bolted directley onto the top of any “Tune-o-matic” guitar body with a small amount of work, via replacing the “Tune-o-matic” tail peice and to any through body strung body as variations.

Will return to the same original position after each operation, Will maintain standard fixed bridge/hard tail tension, could be cost effective to produce, with low operational friction due to rotational pivots

The present invention meets all the above criteria via unconventional means of differential forces created via the hinge points operational shaft and expansion springs that are mounted upon, within/around a folded metal/steel/suitable material frame, which is bolted directley ontop of the guitar body using the two threaded inserts provided for the “Tune-o-matic” tail peice, thus used as anchors which to bolt said tremlo secure ontop of guitar body, thus the “Tune-o-matic” bridge remains compleatley unaltered and with no foreign holes made in/around the guitar body.

Leverage of the springs pulling against the hinged/hook assembley connected to the rotary shaft, is greater than the force created from the pull of strings upon the tremlo tail stop to which said strings are connected, yet the force created by tremlo operating arm is capable of overiding both of these opposing forces, thus wherein said operating force in the direction of shaft rotation is added to the force of either spring or string pull for which ever desired direction, thus allowing a light operating action and as said strings do not have the force to overcome said springs, aided by unconventional force transfer/anchoring via a con-rod, hard tail tension is acheived.

Return to original positon is acheived via an adjustable tailpeice at the end of said operating arm, which thus returns upon a stop block/plate that resists the force of said springs, thus giving the arm a definite point to be held/rest upon, thus holding tremlo to its original position under its own force, which in turn aids tuning stability correct pitch/hard tail tension, whilst still retaining the ability to move above/below standard pitch via pivot of operating arm through x/y axis thus allowing adjustable stop to move above/below stop point and raise/lower pitch at will.

Also said temlo can operate well from cheap materials, as said frame can be folded from sheet steel, thus all part can be assembled upon/within it, with rotational joints which may be lubricated with petrolium jelly/suitable lubricant thus reducing friction, enabling a fluid operation, return to original position, return to pitch and ease of performance.

Also said tremlo can be fitted to any through strung body guitar via simple modifications to said tremlo, that reduce the distance inbetween guitar body and bridge via reducing polarity of operating arm on bridge saddles, or using a roller bar carrier for the strings.

### BREIF DESCRIPTION OF THE SEVERAL VIEWS OF THE DRAWING

FIG. 1; Shows a plan veiw of the standard version of the Thunderline bolt on tremlo system fitted ontop of the guitar body with guitar strings attached

FIG. 2; Is a plan veiw of the standard version Thunderline bolt on tremlo system with cover.

FIG. 3A; Is a side veiw of the non operating side standard version of said tremlo with cover.

FIG. 3B; Is a side veiw of the operating side standard version of said tremlo with cover.

FIG. 4A; Is a front veiw of standard version of said tremlo with cover.

FIG. 4B; Is a rear veiw of standard version of said tremlo with cover.

FIG. 5; Show a plan veiw of standard version of said tremlo without cover.

FIG. 6A; Show a side veiw of the non-operating side of standard version of said tremlo without cover

FIG. 6B; Shows a side veiw of the operating side of standard version of said tremlo without cover

FIG. 7A; Shows a front veiw of standard version of said tremlo without cover

FIG. 7B; shows a rear veiw of standard version of said tremlo without cover.

FIG. 8A; Shows the back/front, plan and underside veiws of spring tension bar for said tremlo.

FIG. 8B; Shows a side veiw of the spring tension pin for said tremlo.

FIG. 8C; Shows side and plan veiws of said tremlo stop block/plate.

FIG. 9A; Shows a front veiw of standard version of tremlo tail stop

FIG. 9B; Shows a rear veiw of standard version of tremlo tail stop.

FIG. 9C; Shows a plan veiw of standard version of tremlo tail stop.

FIG. 9D; Shows a side/back veiw of standard version of tremlo tail stop con-rod pivot.

FIG. 9E; Shows a side veiw of standard version of tremlo tail stop

FIG. 10A; shows a side veiw of said tremlo operating arm

FIG. 10B; Shows a plan veiw of said tremlo operatng arm

FIG. 10C; Shows a side veiw of said tremlo adjustable stop.

FIG. 11A; Shows a sided veiw of said tremlo operating shaft

FIG. 11B; Shows a rear veiw of said tremlo operating shaft con-rod pivot

FIG. 11C; Shows a side veiw of said tremlo operating shaft con-rod pivot

FIG. 11D; Shows a front veiw of said tremlo operating shaft spring pivot.

FIG. 11E; Shows a side version of said tremlo operating shaft spring pivot

FIG. 11F; shows a plan veiw of hook pivot

FIG. 11G; Shows a side veiw of hook pivot

FIG. 11H; shows a plan veiw of hook

FIG. 11I; shows a side veiw of hook

FIG. 11J; Shows a plan veiw of standar version con-rod for said tremlo

FIG. 12A; Shows a plan veiw of both halves of said tremlo tail stop pivot peices

FIG. 12B; Shows a plan veiw of standard version said tremlo frame

FIG. 12C; Shows a plan veiw of both bearing bush insert and for said tremlo.

FIG. 13; Shows a bridge saddle variant of said temlo

FIG. 14A; Shows a side veiw of non operating side of bridge saddle variant of said temlo without cover.

FIG. 14B; Shows a side veiw of operating side of bridge saddle variant of said temlo without cover.

FIG. 15; Shows a plan veiw of bridge saddle variant of frame of said temlo

FIG. 16A; Shows a front veiw of bridge saddle variant of said tremlo without cover.

FIG. 16B; Shows a front veiw of through body strung bridge saddle variant of said tremlo.

FIG. 17A; Shows a front veiw of bridge saddle variant tremlo tail stop.

FIG. 17B; Shows a plan veiw of bridge saddle variant tremlo tail stop.

FIG. 17C; Shows a side veiw of bridge saddle variant tremlo tail stop with dashed line to indicate passage of guitar string through bridge saddle variant tremlo tail stop.

FIG. 18; shows a plan veiw of plan veiw of through body strung bridge saddle variant of said tremlo without cover.

FIG. 19A; Shows a side veiw of non operation side of through body strung bridge saddle variant of said tremlo without cover.

FIG. 19B; Shows a side veiw of operational side of through body strung bridge saddle variant of said temlo without cover.

FIG. 20; Shows a plan veiw of through body strung frame variant of said tremlo.

FIG. 21A; Shows a front veiw of through body strung bridge saddle tremlo tail stop variant.

FIG. 21B; Shows a side veiw of through body strung bridge saddle tremlo tail stop variant.

FIG. 21C; Shows a plan veiw of through body strung bridge saddle temlo tail stop variant.

FIG. 21D; shows a plan veiw of expansion spring FIG. 22A; Shows the front and side veiws of bridge saddle tremlo tail stop con-rod pivot variant.

FIG. 22B; Shows the front and side veiws of through body strung, bridge saddle tremlo tail stop con-rod pivot variant.

FIG. 22C; Shows a plan veiw of bridge saddle variant con-rod.

FIG. 22D; Shows a plan veiw of through body strung bridge saddle variant con-rod.

FIG. 23A; Shows a side front and plan veiw of through body strung variant operational shaft bracket.

FIG. 23B; Shows a plan and side veiw of through body strung operational shaft con-rod pivot variant.

FIG. 24; Shows a plan veiw of through body strung tune-o-matic bridge variant of said tremlo without cover.

FIG. 25A; Shows a side veiw of non operating side of through body strung tune-o-matic bridge variant of said tremlo without cover.

FIG. 25B; Shows a side veiw of operating side of through body strung tune-o-matic bridge variant of said tremlo without cover.

FIG. 26A; Shows a front veiw of through body strung tune-o-matic variant of said tremlo without cover.

FIG. 26B; Shows plan and side veiws of through body strung tune-o-matic variant roller bar pivot peices.

FIG. 26C; Shows plan and side veiws of through body strung tune-o-matic variant tie bar connectors

FIG. 26D; Shows plan and side veiws of through body strung tune-o-matic variant con-rod.

FIG. 27A; Shows a side veiw of through body strung tune-o-matic variant roller bar.

FIG. 27B; Shows a side veiw of through body strung tune-o-matic variant tie bar

FIG. 27C; Shows a plan veiw of through body strung tune-o-matic variant frame.

FIG. 28A; Shows a front veiw for cover of said tremlos

FIG. 28B; shows a plan veiw for cover of said tremlos

FIG. 29A; Shows a rear veiw for the cover of said tremlos

FIG. 29B; Shows side veiw of non operating side of cover for said tremlos

FIG. 29C; Shows a side veiw of operating side of cover for said tremlo

FIG. 30A; Shows standard version of said tremlo in non-operational position with guitar string attatched over tune-o-matic bridge.

FIG. 30B; Shows tremlo in operational positon to lower string tension and pitch.

FIG. 30C; Shows tremlo in operational position to raise string tension and pitch.

### DETAILED DESCRIPTION OF INVENTION

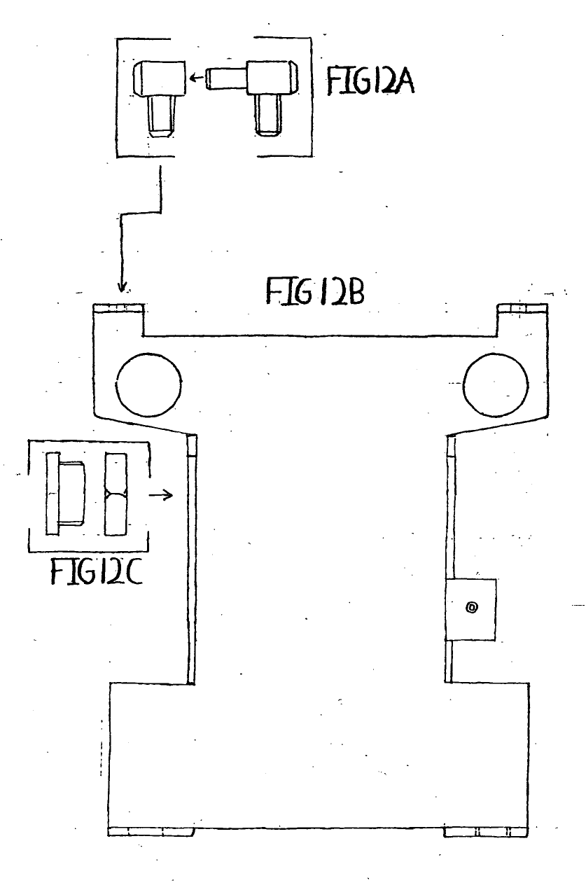

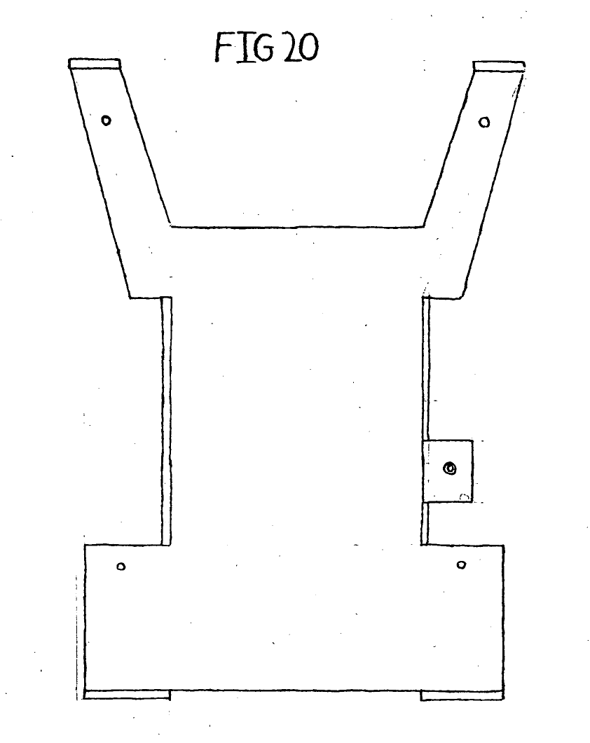

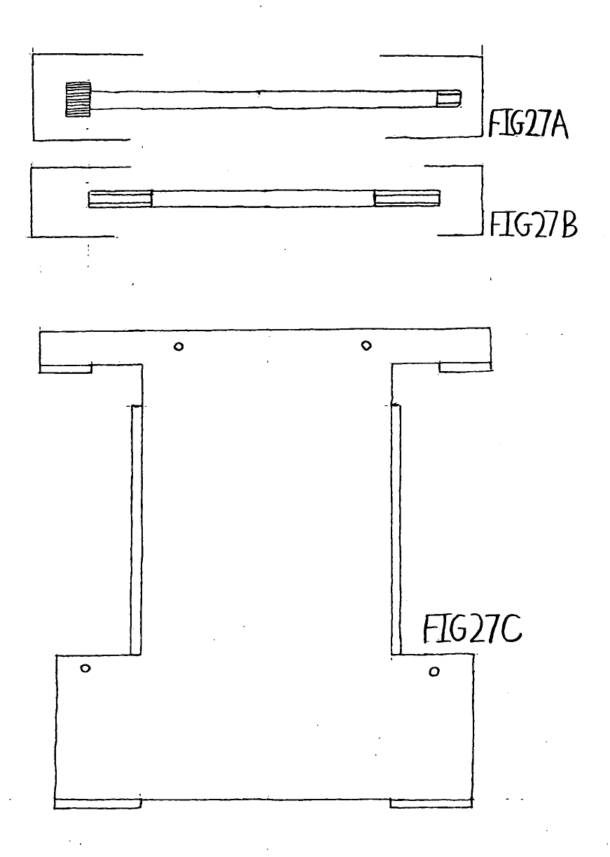

The frame for said tremlo is made from steel/suitable metal sheet a minimum of 2 mm thick marked out as per FIG. 12B, FIG. 20, FIG. 27C (note if constructing by hand tools allow 2 mm in between side fold line and base) thus all holes are drilled and tapped out as per FIG. 12B, FIG. 20, FIG. 27C, thus all excess material is removed from around template and deburred, thus allowing all sides around template to be folded 90 degrees vertical from base section of said tremlo frame FIG. 12B, FIG. 20, FIG. 27C, which may be done by hand or mechanical press and suitable constructed jig.

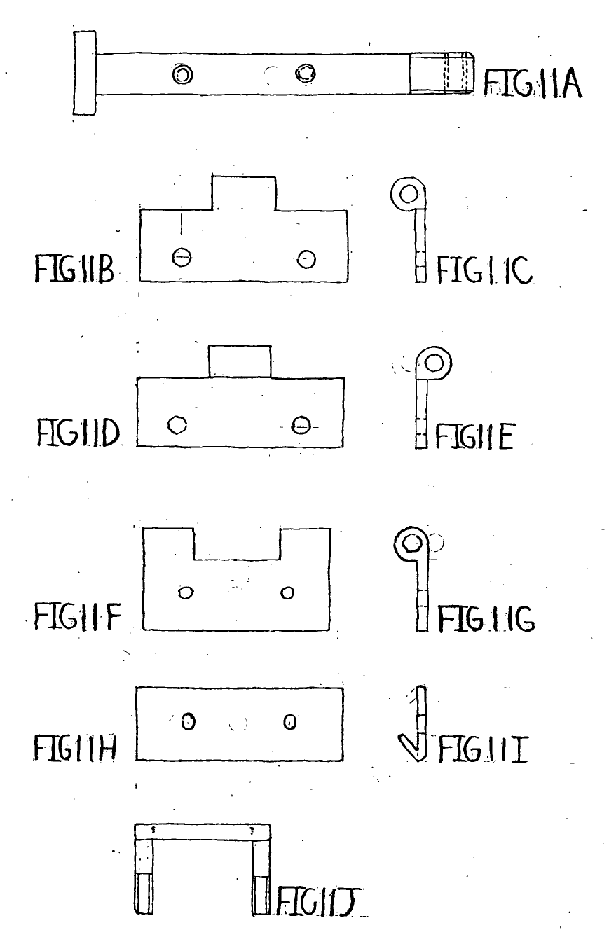

A pair of threaded insert bearng bushes (FIG. 12C) are made from brass/phosphor bronze or similar material rod, turned upon a suitable lathe with an intended bore 0.080 thou larger than the diameter of the operating shaft (FIG. 11A), thus the outside of of said bearing bush (FIG. 12C) is threaded to a sitable size, either by lathe or hand die, to match a nut (FIG. 12C) of corresponding thread, size and material

The operating shaft (FIG. 11A) is machined/turned upon lathe from steel/similar material rod as per fig, thus blank said operating shaft (FIG. 11A) is then drilled and tapped through the vertical and horzontal axis 90 degrees to coresponding threaded holes as per fig.

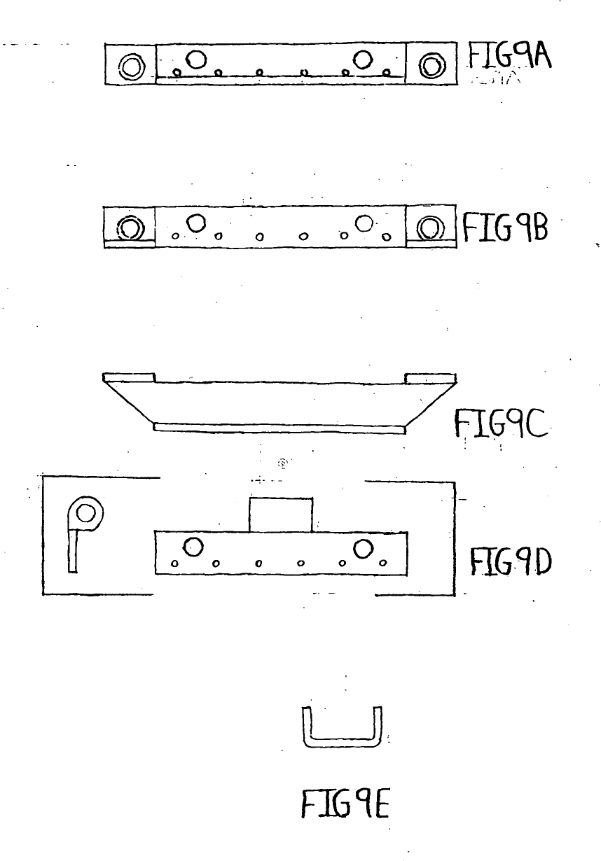

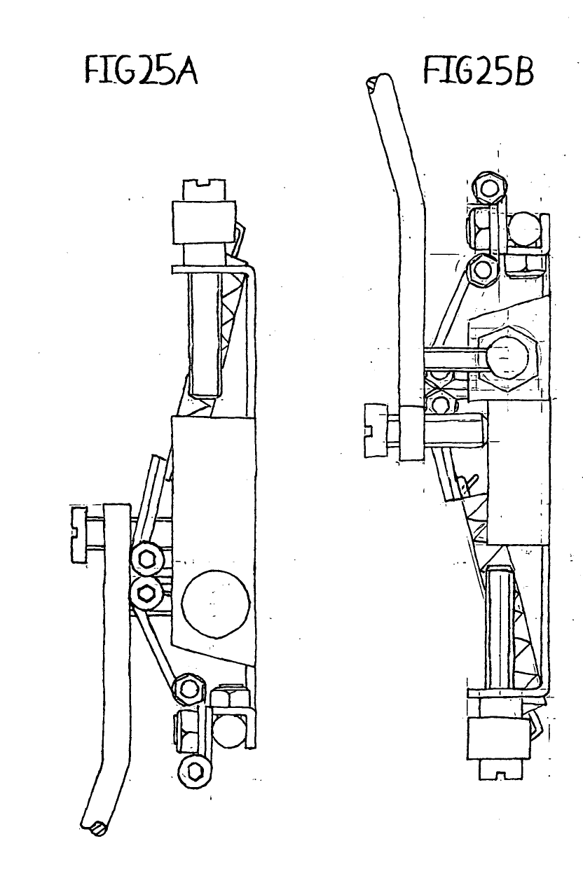

The tremlo tail stop (FIG. 9A, 9B, 9C) is made from 2 mm minimum sheet steel/suitable metal, then mared out as per FIG. 9A, FIG. 9B, FIG. 9C, whereafter all excess material is remove via blade or machine punch, to which all burrs are removed clearance holes drilled as per FIG. 9A, FIG. 9B, FIG. 9C, then required part of is then folded 90 degrees verticaly as per FIG. 9E, yet also may be made to thus fold vertically from the opposite direction as used per FIG. 25A, FIG. 25B, FIG. 27C if tremlo tail stop (FIG. 9A, FIG. 9B, FIG. 9C) is desired to be in line with the front of said tremlo thus this modification may be done to all varients.

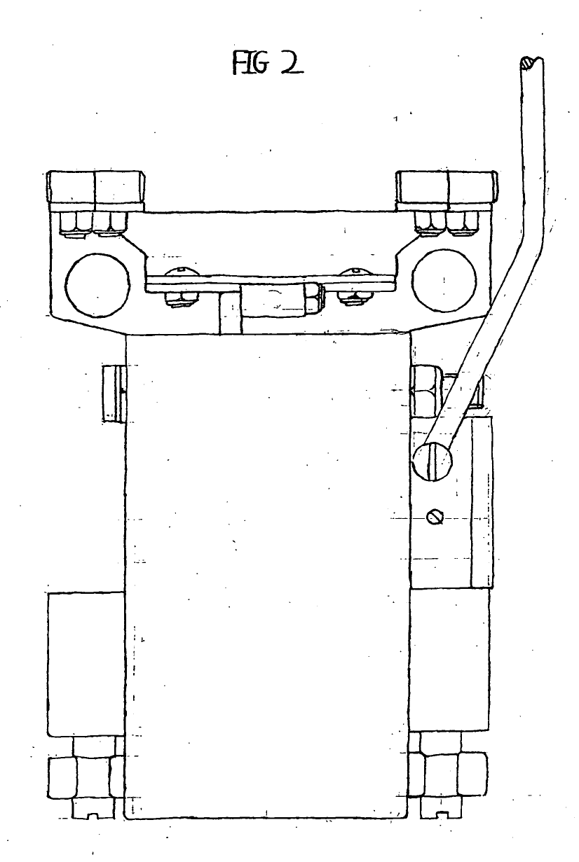

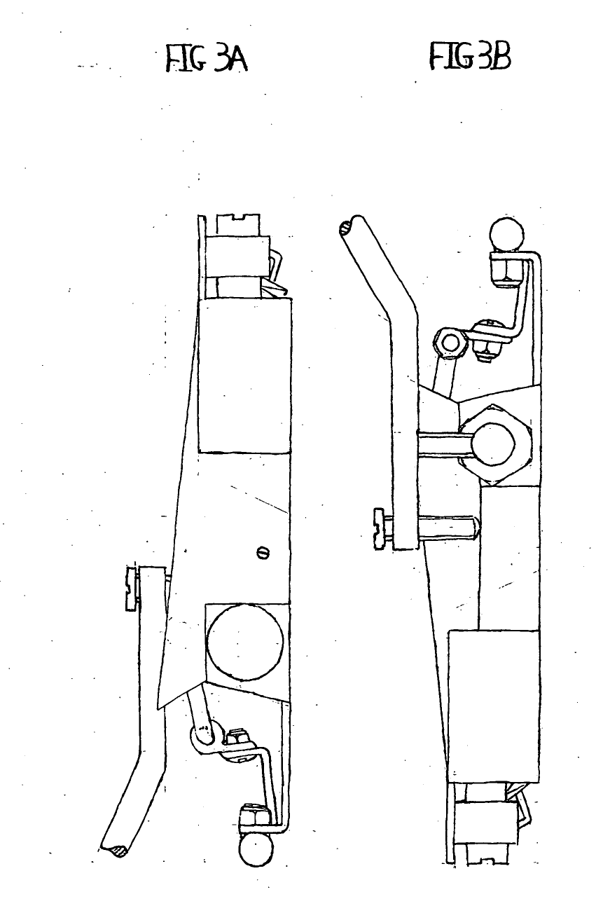

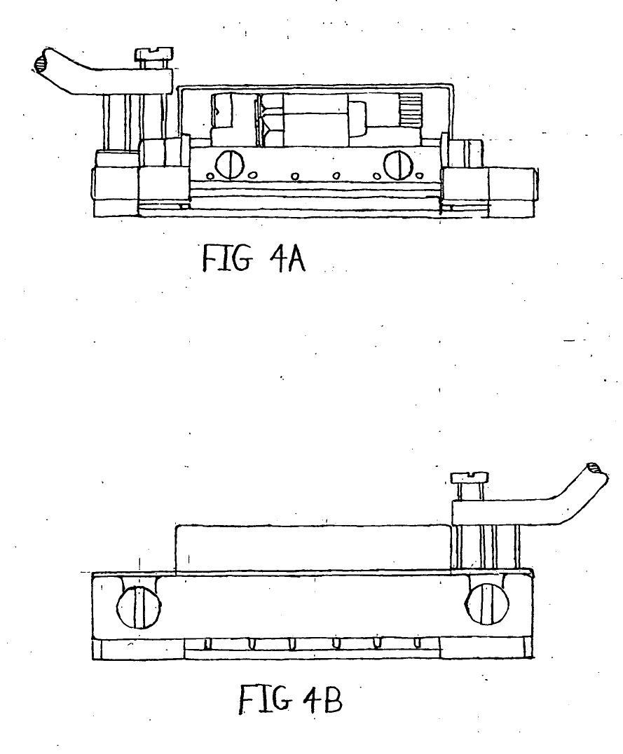

The pivot hinge peices (FIG. 12a) for rotation of tremlo tail stop (FIG. 9A, 9B, 9C), are manufactured from brass/phosphor bronze of similar material, thus each half is milled and turned as per FIG. 12A, from suitable rod lengths of said material which are then threaded as per FIG. 2A, via corresponding die

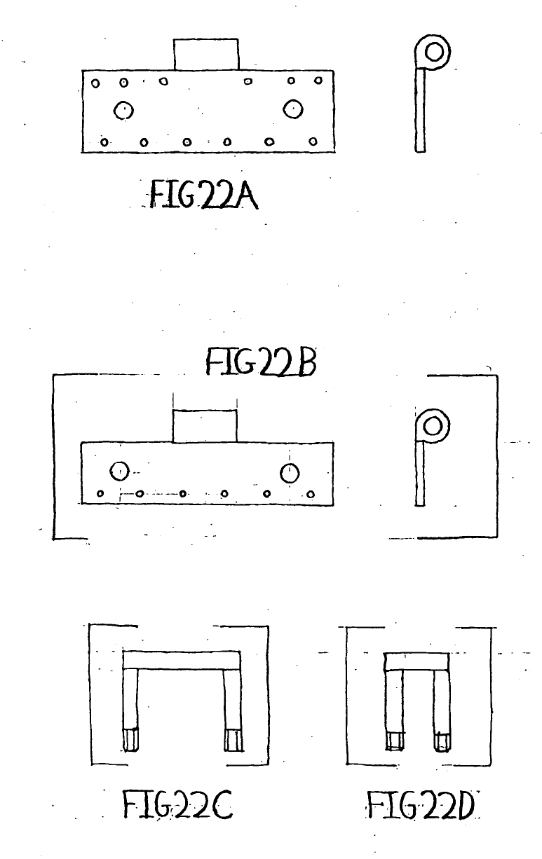

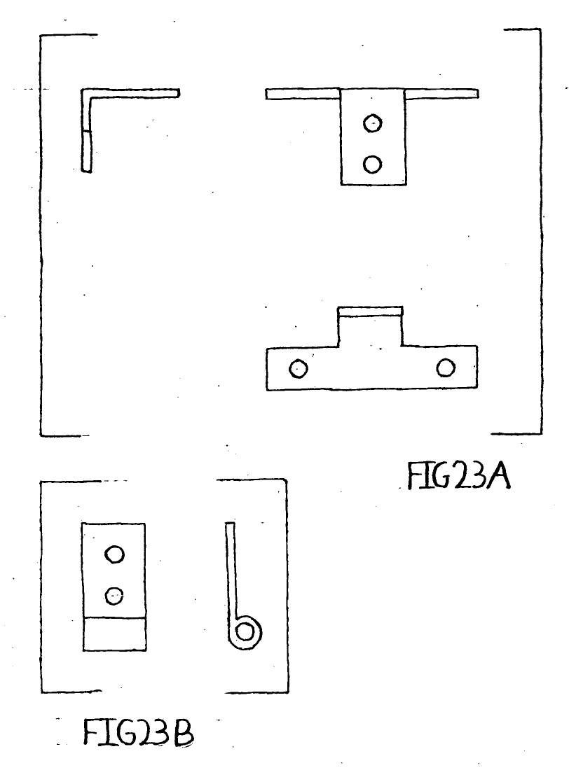

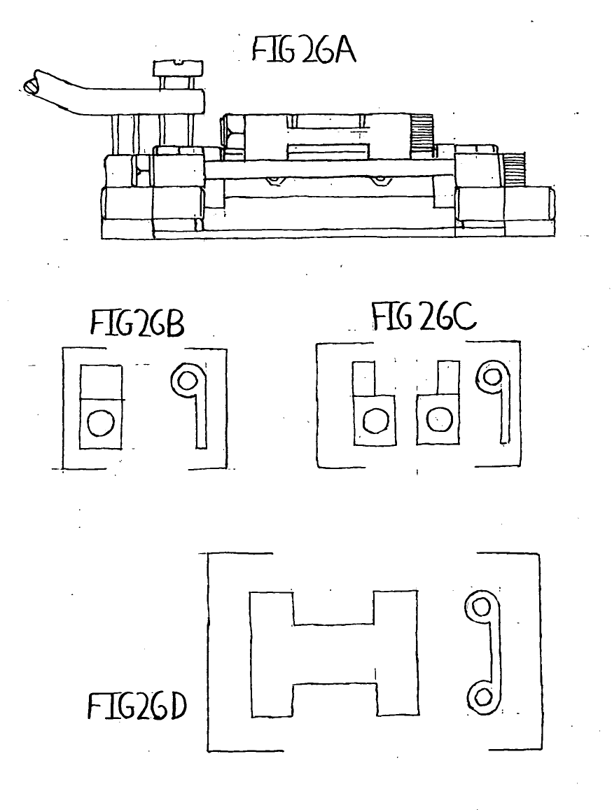

All broad pivot parts (FIG. 9D, FIG. 11B, FIG. 11C, FIG. 11D, FIG. 11E, FIG. 11F, FIG. 11G, FIG. 22B, FIG. 23B, FIG. 26B, FIG. 26C, FIG. 26D) are made from brass/phoshpor bronze or similar material blocks, of a suitable size and are then milled and drilled to FIG. 9D, FIG. 11B, FIG. 11C, FIG. 11D, FIG. 11E, FIG. 11F, FIG. G, FIG. 22B, FIG. 23B, FIG. 26B, FIG. 26C, FIG. 26D individually to quantity required.

The spring hook (FIG. 11H, FIG. 11I) is made from 2 mm minimum sheet steel/suitable metal, then marked out flat as per FIG. 11H, FIG. 11, thus hook is cut/machine punched out flat, with clearance holes, individual hooks which are then folded to a suitable angle as per FIG. 11H and finaly deburred

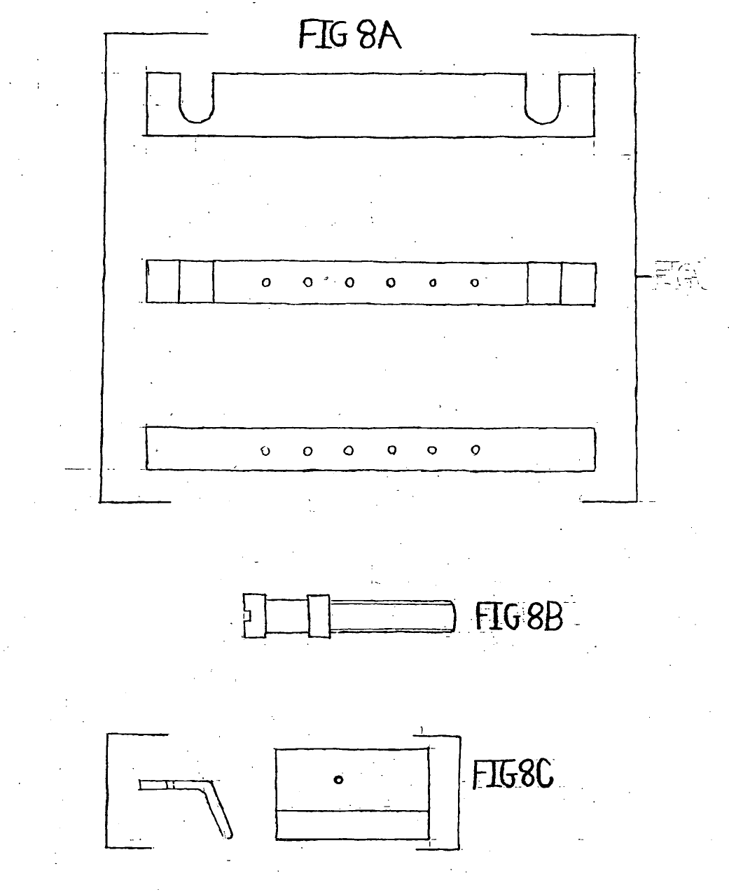

The spring tension adjustment bar (FIG. 8A) is made from a single square bar of steel/suitable material, which is then marked out as per FIG. 8A, then milled and drilled with clearance holes and slots as per FIG. 8A, before being debured to compleate constrction of said spring tension adjustment bar, which may also be cast and cleaned up by manufacturer is so desired.

The spring tension adjestment pins (FIG. 8B) are made from steel/suitable metal rod material whence they are tuned upon lathe to suitable stepped diameters, before a suitable thread is cut, via lathe or die, upon the longest blank, thus producing a pin as per FIG. 8B

The con-rod (FIG. 11J, FIG. 22C, FIG. 22D) is made from a rod of steel/or prefered high tensile steel/suitable metal rod of prefered diameter (FIG. 11J, FIG. 22C, FIG. 22D, to either end of said rod a threaded bolt/cap head bolt is welded at 90 degrees parallel to each other and facing the same direction, yet also thus welding is only to be done from top of bolt head to preserve flat beneath bolt, also is said high tensial steel is prefered suitable high tensial rod must be used, but said con-rod (FIG. 11J, FIG. 22C, FIG. 22D) must not be quenched as this will result in brittle con-rod (FIG. 11J, FIG. 22C, FIG. 22D), yet this iteam may be cast cleaned up and threaded from mould if prefered by manufacturer.

The tremlo stop block/plate (FIG. 8C) is made from 2 mm minimum sheet steel/suitable material sheet, marked out as per FIG. 8C fig, then cut/machine punched out, before being drilled to a clearance size (FIG. 8C), folded as per FIG. 8C, and finally deburred

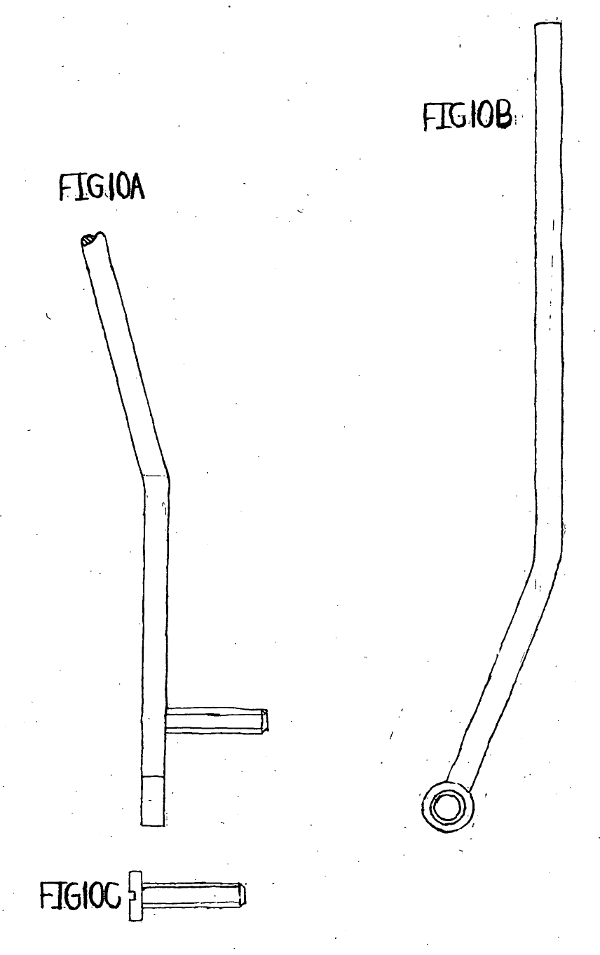

The operating arm (FIG. 10A, FIG. 10B) is constructed from a rod of steel/suitablemetal, to which a shorter threaded rod (FIG. 10A, FIG. 10B) is welded to at 90 degrees to the longer rod which is thus allowed to air cool, to which a threaded bush then welded to the end of said long rod, to the end nearest said threaded rod, thus allowing a suitable set pin to be screwed into the welded threaded bush thus producing an adjustable tail stop (FIG. 10C) and compleating said operating arm (FIG. 10A, FIG. 10B, FIG. 10C)

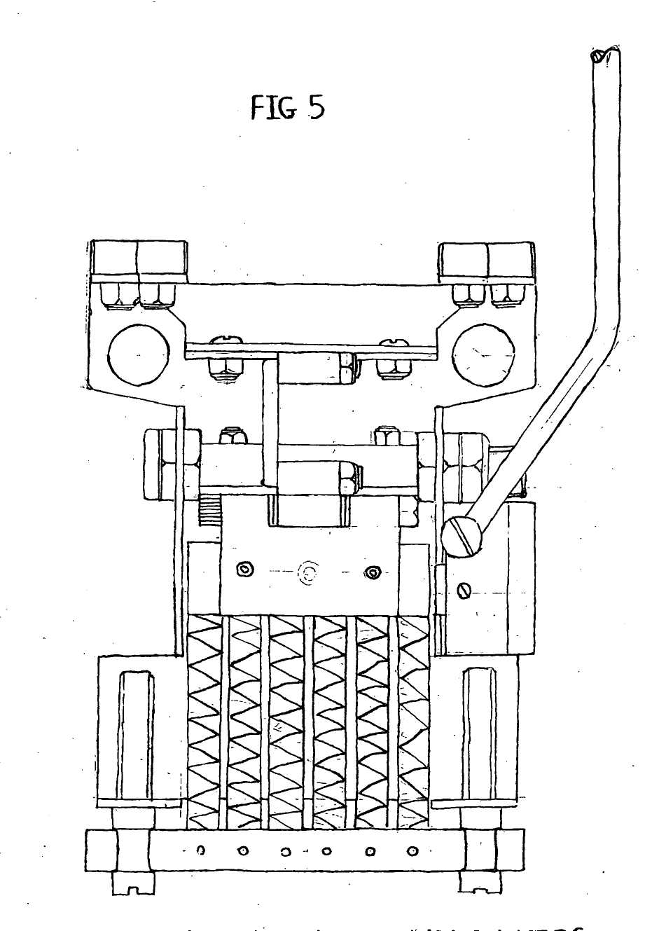

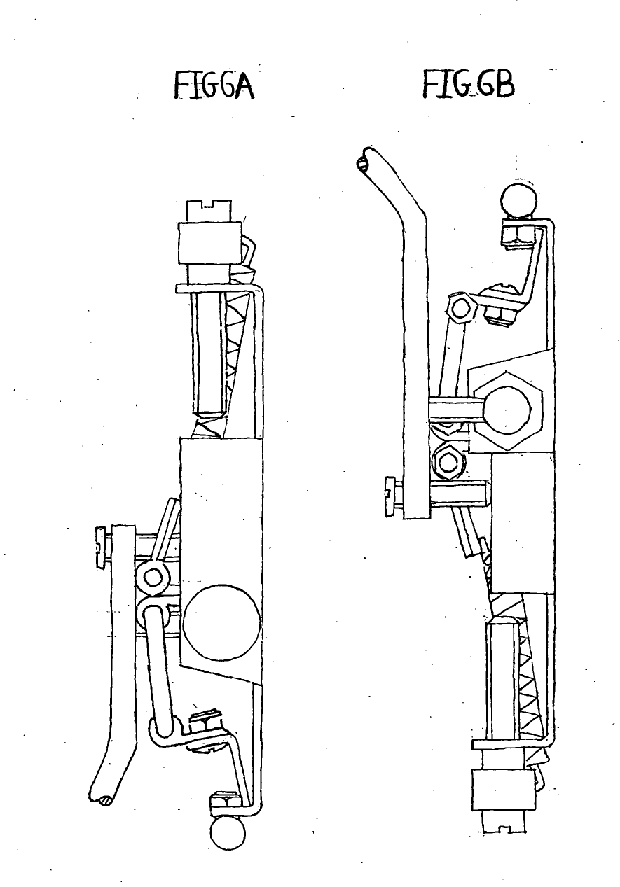

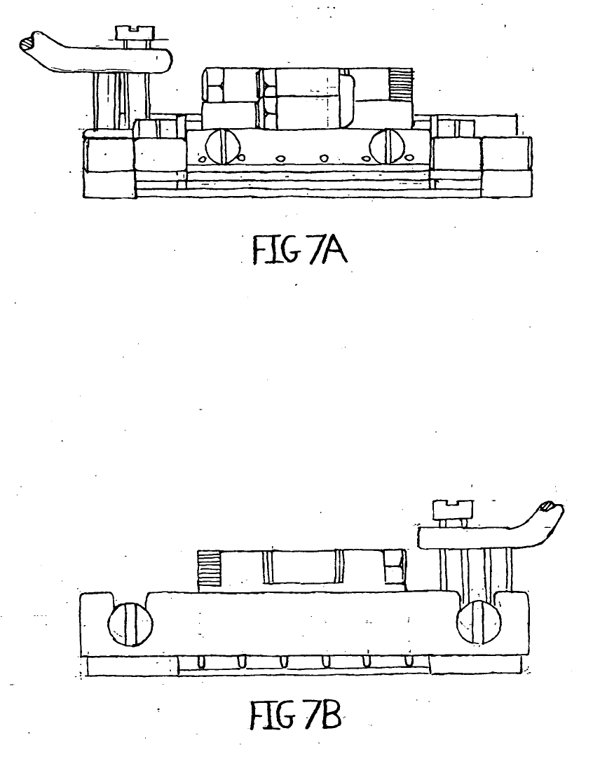

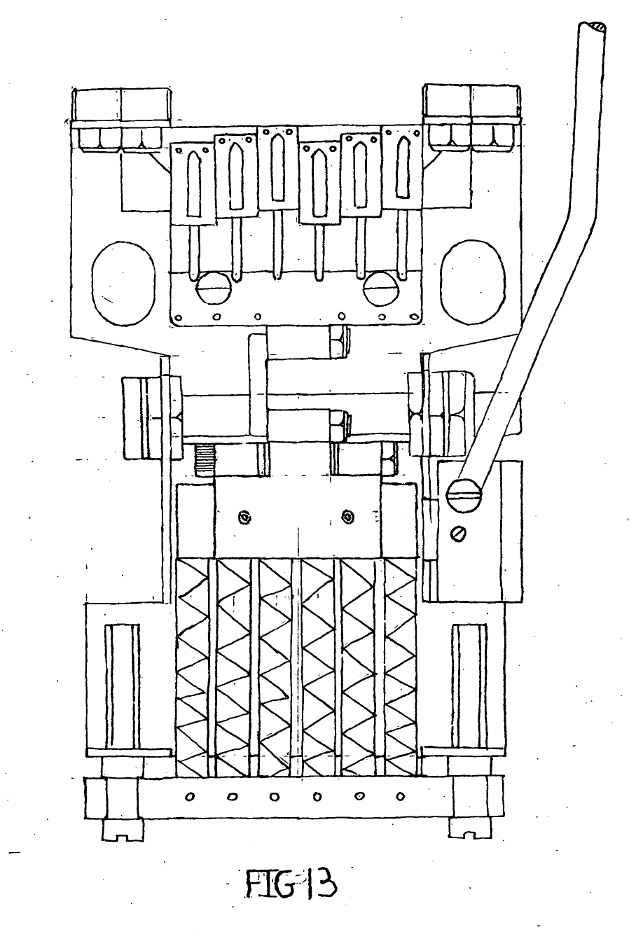

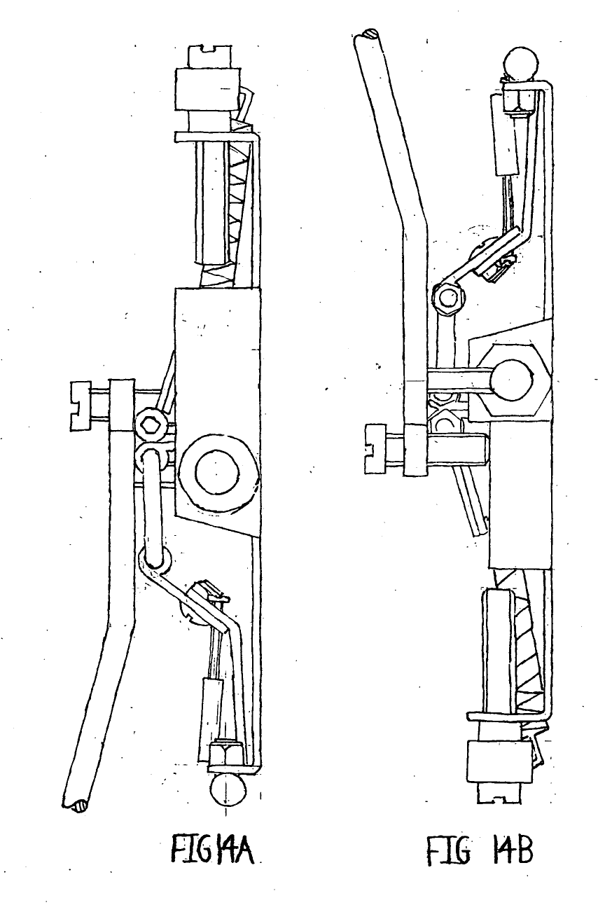

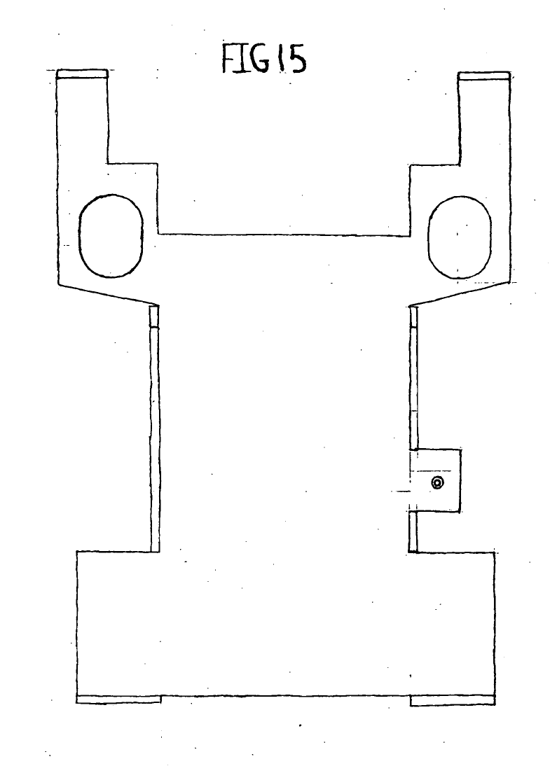

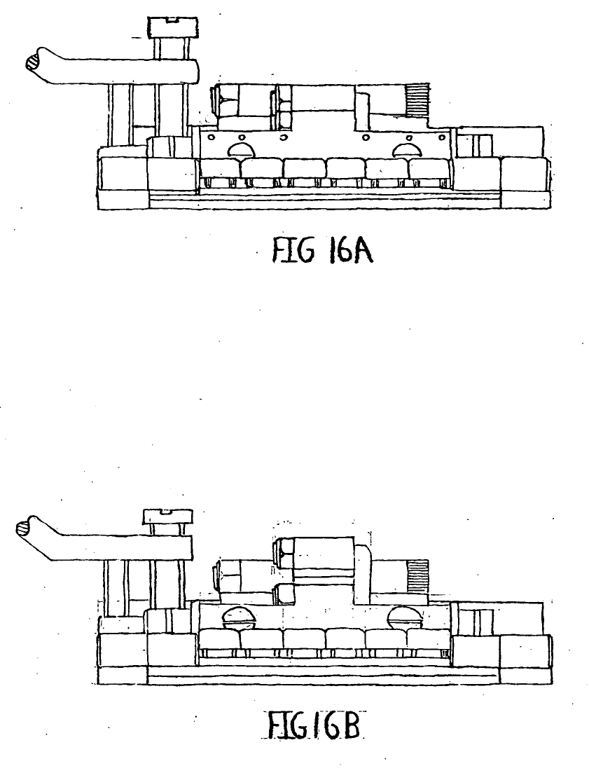

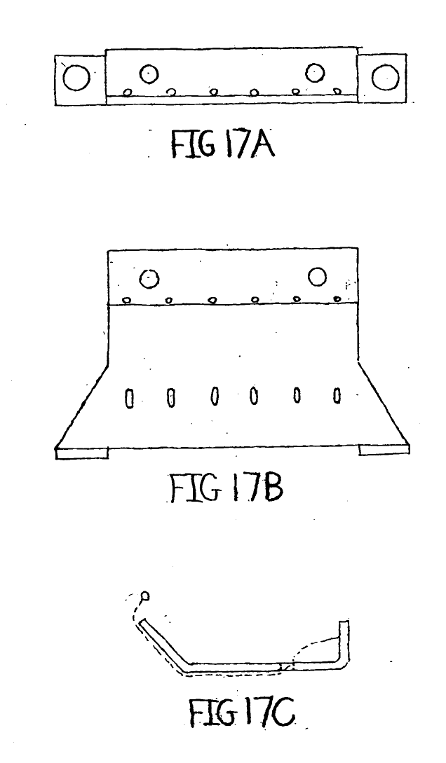

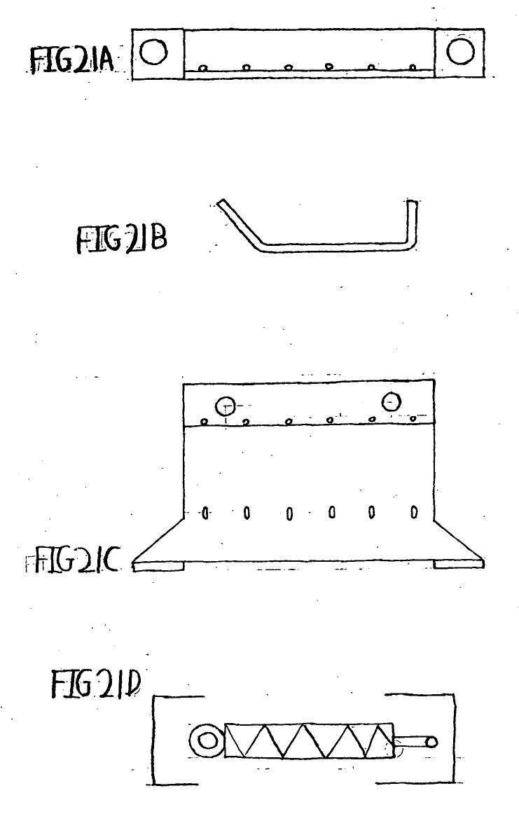

All variants comprise of the same materials as said standard version (FIG. 2, FIG. 5, FIG. 6, FIG. 7), thus bridge saddle tremlo tail stop (FIG. 13A, FIG. 13B, FIG. 13C) is made from 2 mm sheet steel/suitable material which is then, marked out, drilled, cut and folded as per FIG. 21A, FIG. 21B, FIG. 21C, and such the con-rod pivot (FIG. 22A) is maded in the same way as FIG. 9D, yet to FIG. 22A, designation and thus the variant con-rod (FIG. 22C) is constructed using the same methods and materials as FIG. 11J, thus variant frame (FIG. 15) is made the same way as FIG. 12B.

The through body strung bridge saddle variant is made all the same materials as said standard version FIG. 2, thus the tremlo tail stop (FIG. 21A, FIG. 21B, FIG. 21C) is made from 2 mm sheet steel or suitable material is measured, marked out, drilled cut and folded as per FIG. 21A, FIG. 21B, FIG. 21C, thus the con rod pivot is been constructed using the same materials and methods as per FIG. 22A, yet to FIG. 22B, and thus the operational shaft con-rod pivot (FIG. 23B) and bracket (FIG. 23A), is constructed from a mild steel sheet/suitable material and manufactured via marking out as FIG. 23A, cutting or punching out and folding, thus producing FIG. 23A, along with FIG. 23B, which is constructed using same methods and materials as FIG. 9D, therein con rod FIG. 22D is constructed using the same method and materials as FIG. 11j, thus frame (FIG. 20) is constructed using the same materials and methods as per FIG. 12B.

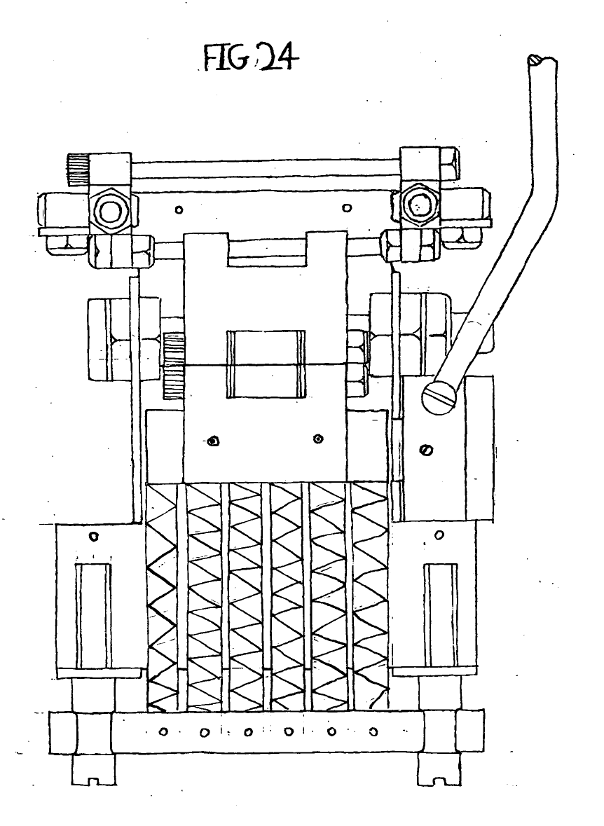

The through body strung tune-o-matic style variation (FIG. 24) tail peice parts (FIG. 26B, FIG. 26C) are constructed in the same way/suitable material parts as FIG. 9D, yet are cut and drilled as variant FIG. 26B, FIG. 26C ₁ as is the flat con-rod (FIG. 26D) to which corresponding tie bar (FIG. 27B) is made from a single suitable rod of steel/suitable material, threaded at either end as per FIG. 27B, to accomadate two corresponding lock nuts at either end, thus the tremlo roller bar (FIG. 27A) that can be either a standard stock corresponding cap head bolt, or constructed the same as FIG. 27B, thus frame (FIG. 27C) is constructed using the same methods and materials as FIG. 12B.

Assembley of the Thunderline bolt on tremlo (FIG. 2) begins with folded frame of prefered designation (FIG. 12B), onto which both bearing bush inserts (FIG. 12C) are bolted secureley to each long side acomadating hole, thus allowing the operating shaft (FIG. 11A) to be slide through both bearing bush inserts (FIG. 12C), whilst retining a washer against the outside of each bearing bush insert, wherein a suitable nylon lock nut is screwed upon operating end of operation shaft (FIG. 11A), thus retaining said shaft within frame, yet still retaining ease of rotation.

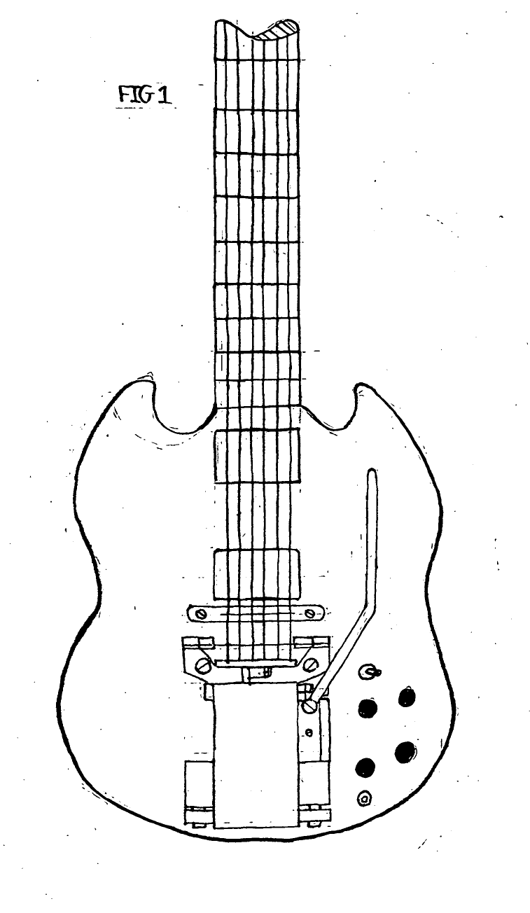

futher assembley of said tremlo system requires brass pivot peices (FIG. 11B, FIG. 11C, FIG. 11D, FIG. 11E, FIG. 11F, FIG. 11G) and hook (FIG. 11H, FIG. 1J) to be assembleled upon each other and said shaft (FIG. 11), thus operational shaft con-rod pivot (FIG. 11B, FIG. 11C) along with spring tenson pivot (FIG. 11D, FIG. 11E) are bolted to the rear of said operation shaft (FIG. 11A), using standard countersunk caphead set pins and corressponding retaining nylon lock nuts, thus hook pivot (FIG. 11F, FIG. 11G) is secured to said spring tension pivot (FIG. 11D, FIG. 11E) via standard stock cap head bolt whilst fitting corressponding washers either side of said spring tension pivot to reduce wear and friction wherein said cap head bolt is retained using suitable nylon lock nut, thus hook (FIG. 11H, FIG. 11J) is rivetted to hook pivot (FIG. 11F, FIG. 11G)

Futher asembley of said tremlo system is acheived via screwing threaded spring tension adjustment pins (FIG. 8B) into the rear of chosen frame (FIG. 12B) thus both said adjustment pins (FIG. 8B) are parrallel with long sides of said chosen frame, thus spring tension bar (FIG. 8A) may be fitted verticaly from base of frame whilst spanning the complete width of said chosen frame (FIG. 12B) and fitting home inbetween both rear shoulders of each spring tension adjustment pins (FIG. 8B), thus allowing all six expansion springs (FIG. 21D) to be fifted from hook (FIG. 11H, FIG. 11J) to tension bar (FIG. 8A) wherein eye of said spring (FIG. 21D) fits over hook (FIG. 11H, FIG. 11J), ninety degree hook end of said spring (FIG. 21D) slides up into tension bar (FIG. 8A), thus spring tension is connected to operational shaft (FIG. 11A).

Further assembley of said tremlo system is acheived via fitting one half of each pair of pivot peice (FIG. 12A) to the front of chosen tremlo frame (FIG. 12B) and secred into place via suitable corressponding nylon lock nut, thus second half of each pair of pivot peices (FIG. 12A) is slid on/into first half wherein tremlo tail stop of chosen design (FIG. 9A, FIG. 9B FIG. 9C, FIG. 9E) is secure to using suitable nylon lock nut, thus allowing tremlo tail stop (FIG. 9A, FIG. 9B, FIG. 9C, FIG. 9E) to pivot upon frame, wherein con-rod tremlo tail stop pivot (FIG. 9D) is bolted/riveted to rear/front of chosen said tremlo tail stop (FIG. 9A, FIG. 9B, FIG. 9C, FIG. 9E) accordingly, thus suitable con rod (FIG. 1J) may be fitted inbetweenoperational shaft con-rod pivot (FIG. 11C) and tremlo tail stop con-rod pivot (FIG. 9D) from non operating side to operating side and thus retained into place via corressponding nylon lock nuts

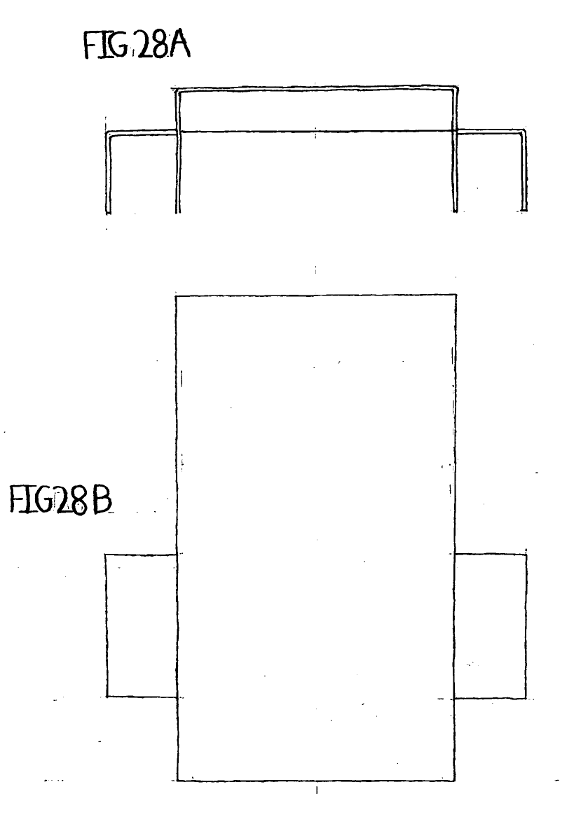

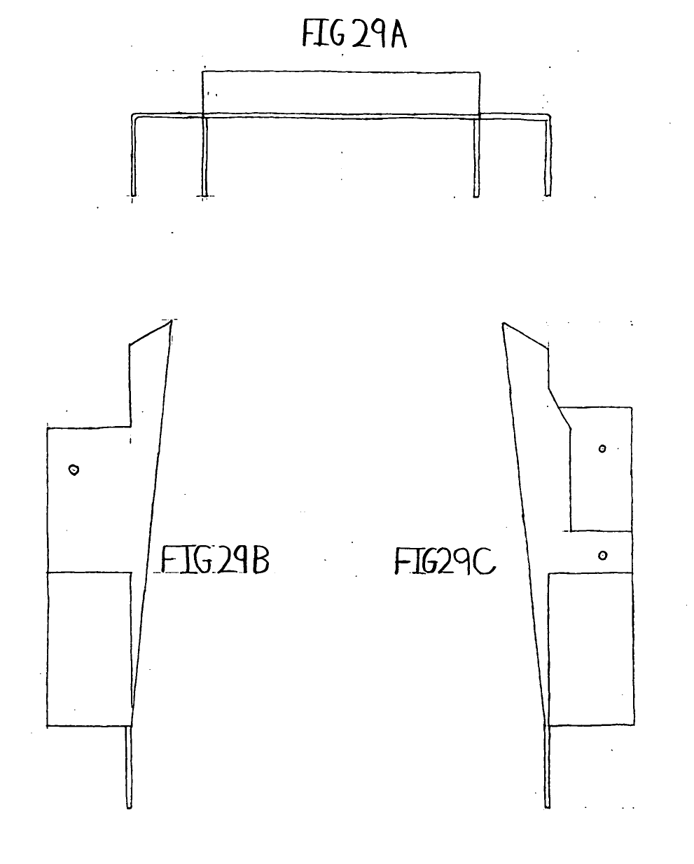

Further assembley of said tremlo system is acheived via screwing operating arm (FIG. 10A, FIG. 10B) into threaded hole of operation shaft (FIG. 11A) to the required height and the screwing adjustable tail stop (FIG. 10C) into rear of tremlo operating arm (FIG. 10A, FIG. 10B) wherein tremlo cover (FIG. 28A, FIG. 28B, FIG. 29A, FIG. 29B, FIG. 29C) is then fitted and retained via two small slotted set pins upon either side of said temlo (FIG. 2), thus tremlo stop block/plate (FIG. 8C) is then fitted upon tab on operating side of said tremlo (FIG. 2), wherein said tremlo stop block/plate (FIG. 8C) is retain via suitable set pin and thus adjustable tremo stop (FIG. 10C) is placed upon tremlo stop block/plate (FIG. 8C), to which spring tension is taken up via said adjustment pins (FIG. 8B) to desired amount.

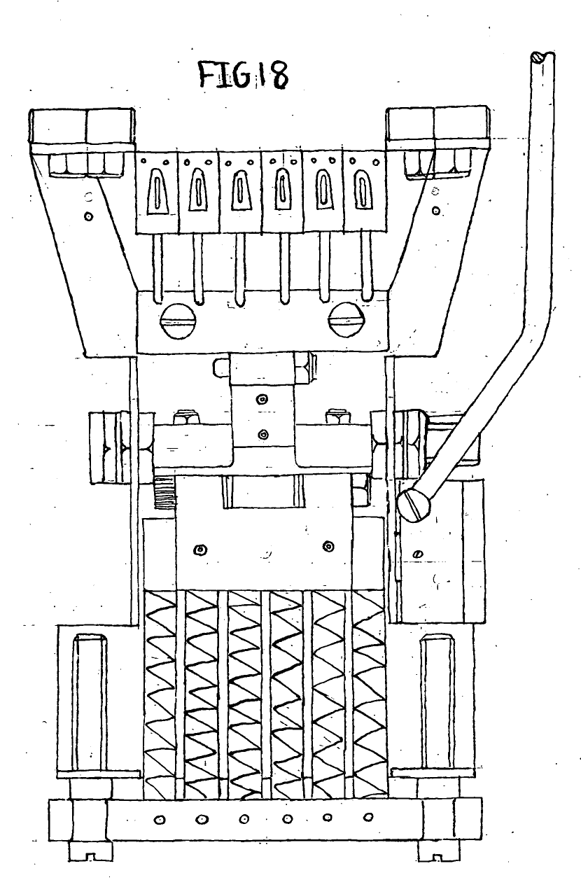

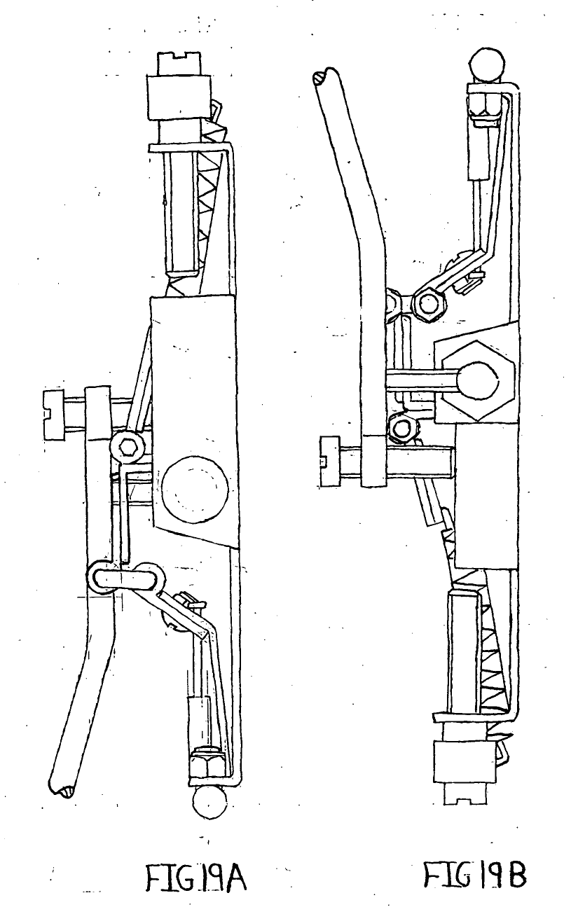

Variant assembley of tremlos (FIG. 13, FIG. 18, FIG. 24) is the same as standard version (FIG. 2) with exception of fitting bridge saddles to variations FIG. 13 and FIG. 18, yet through body strung bridge saddle variation (FIG. 18) requires variant operational shaft con-rod pivot (FIG. 23B) and bracket (FIG. 23A) to be fifted which extends directly above the variant bridge saddle tremlo tail stop (FIG. 21A, FIG. 21B, FIG. 21C), thus requiring variant con-rod (FIG. 22D) as does bridge saddle variant (FIG. 13) with con-rod (FIG. 22C, wherein through body strung tune-o-matic variation (FIG. 24) has its tremlo tail stop fully assembled upon both inside pivot peices (FIG. 12A) which point vertically up from said tremlo frame (FIG. 27C), thus roller bar pivot peice (FIG. 26B) is placed over vertical shaft in a horizontal position pointing out beyond the front of the frame, to which the tie bar connectors (FIG. 26C) a laid on top of said roller bar pivots (FIG. 26B) yet pointing back towards the springs, with the bore of said connector on the inside, parallel with the centre line of tremlo frame (FIG. 27C), thus nylon lock nut is used to retain both said FIG. 26B and FIG. 26C squarley upon pivot peices (FIG. 12A) as flat con-rod (FIG. 26D) is fitted to standard operational shaft con-rod pivot (FIG. 11B, FIG. 11C), thus allowing tie bar (FIG. 27B) to be slid through tie bar conectors (FIG. 26C) and flat con-rod (FIG. 26D), wherein it is secured firmly by four corresponding nylon lock nuts, thus roller bar (FIG. 27A) is slid through roller bar pivots (FIG. 26B) and retained via corresponding nylon lock nuts, yet allowing ease of rotation, thus connecting the assembled roller bar tremlo tail stop to said operational shaft, thus producing FIG. 24.

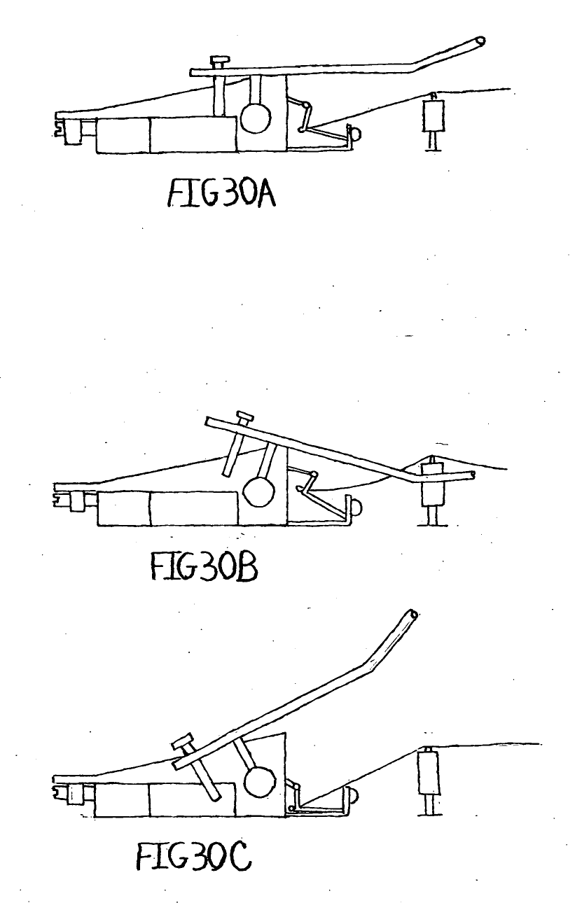

To operate thus making pitch lower, strum guitar and push said operating arm (FIG. 10A, FIG. 10B) towards the guitar body, thus lifting adjust stop (FIG. 10C) up and away from stop block/plate (FIG. 8C), wherein operating shaft (FIG. 11A) is rotated towards said tremlo tail stop (FIG. 9A, FIG. 9B, FIG. 9C, FIG. 9E), thus pulling against said springs (FIG. 21D) via pivot/hook (FIG. 11F, FIG. 11G, FIG. 11H, FIG. 11I) assembley, whilst pushing said con-rod (FIG. 11J) forward towards tremlo tail stop (FIG. 9A, FIG. 9B, FIG. 9C, FIG. 9E), thus in turn pushing the tremlo tail stop (FIG. 9A, FIG. 9B, FIG. 9C, FIG. 9E) forward towards the guitar bridge, which in turn slackens string as per FIG. 30B, thus opererating arm FIG. 10A, FIG. 10B) is pulled away from guitar body untill adjustable stop (FIG. 10C) comes to rest upon stop block/plate (FIG. 8C), ths returning to pitch and standard hard tail tension as per FIG. 30A, yet in order to raise tension and pitch, pull said operating arm (FIG. 10A, FIG. 10B) across guitar strings, thus swinging adjustable stop (FIG. 10C) clear of said stop block/plate (FIG. 8C) thus allowing operating arm (FIG. 10A, FIG. 10B) to be pulled away from guitar body, which in turn enables adjustable stop (FIG. 10C) to lower beyond said stop block/plate (FIG. 8C), wherein operation shaft (FIG. 11A) rotates towards saidsprings (FIG. 21D) thus pulling con-rod (FIG. 11J) back towards said springs (FIG. 21D), thus lowering said tremlo tail stop (FIG. 9A, FIG. 9B, FIG. 9C, FIG. 9E) which in turn pulls guitar strings tight over guitar bridge thus raising pitch and string tension as per FIG. 30C, thus when operation is compleate, said tremlo (FIG. 2) is returned to position FIG. 30A, therefore operator can move fluidly through all positions to acheive desired effect, thus all tremlos are operated in the same way, however mechanisms may differ.

The advantages of the thunderline bolt on tremlo system are such that, the player can have one guitar one stage instead of two, as long as the guitar is of tune-o-matic design you do not need to make any alterations or extra holes in the guitar body, but simpley use the threaded inserts situated for tail peice anchorage, yet for any guitar that has strigs anchored directley through the guitar body you will need to make screw holes in the guitar body to fit such variants as there is no tail peice, however for such through strung body guitars threre is no tremlo design available that will allow said guitar to retain its through body strung status, thus also the thunderline bolt on tremlo system does not relie upon string tension in any way for operation and therefore has a greater flexability of variation, since there is also no reliance upon sliding plates, micro bearings, compresion spring or locking devices as with other tremlos, thus all return to pictch is controlled by the operator via mechanical means that are within the operators means to control without any external influences from said guitar, thus said guitar will always return to pictch since adjustable stop always returns to the same position upon tremlo stop block/plate (FIG. 8C), thus the bolt on term refers to the retro fitting of said tremlo upon existing tail peice holes or the direct fixing upon an unblemished guitar body, as such all above is created by separating the string anchorage from the springs via a con-rod, thus creating a differential in force, which is what makes this tremlo effective and no other tremlo available today has.

1. I claim that this is fitted tremlo unit designed to replace the tail peice of a “Tune-o-matic” bridge guitar whilst leaving the bridge peice compleatley unaltered upon the guitar body with the strings at standard hard tail tension due to the separation of the tremlo tail peice and springs via a con-rod thus eliminating the need for string tension and/or synchronized balance with the springs to return to pitch.

2. I claim that the frame/tremlo sits on top of the guitar body using the “Tune-o-matic” tail peice threaded inserts in the guitar body as static anchors

3. I claim that the tremlo unit needs no additional screw holes provided the guitar is of “Tune-o-matic” designation.

4. I claim that the tremlo holds the strings at standard hard tail tension due to the force differential in favour of the springs created by the leverage of the hinge/spring asssembley mounted on a rotaing shaft within a frame and separated via a con-rod arrangement to the tremlo tail peice

5. I claim that the force differential created by the hinge/spring/shaft and con-rod assembley also allows for a light operating action of the tremlo system

6. I claim that the tremlo not only holds standard hard tail tension but can also take string tension up as well as down in tension due to the adjustable stop at the end of the operating arm which when moved away from the stop block can then move above or below the stop block rotating the shaft and moving the con-rod back and forth to produce the desired tremlo effect.
